(19) United States
(12) Patent Application Publication
(10) Pub. No.: US 2013/0326114 A1
(43) Pub. Date: Dec. 5, 2013

(54) WRITE MITIGATION THROUGH FAST REJECT PROCESSING

(71) Applicants: Ryan James Goss, Prior Lake, MN (US); David Scott Seekins, Shakopee, MN (US); Mark Allen Gaertner, Vadnais Heights, MN (US)

(72) Inventors: Ryan James Goss, Prior Lake, MN (US); David Scott Seekins, Shakopee, MN (US); Mark Allen Gaertner, Vadnais Heights, MN (US)

(73) Assignee: SEAGATE TECHNOLOGY LLC, Cupertino, CA (US)

(21) Appl. No.: 13/484,037

(22) Filed: May 30, 2012

(51) Int. Cl. G06F 12/00

(52) U.S. Cl. 711/103; 711/161; 711/E12.008

(57) ABSTRACT

Apparatus and method for data management in a memory, such as but not limited to a flash memory array. In accordance with some embodiments, a first hash value associated with a first set of data stored in a memory is compared to a second hash value associated with a second set of data pending storage to the memory. The second set of data is stored in the memory responsive to a mismatch between the first and second hash values.

### SUMMARY

Various embodiments disclosed herein are generally directed to the management of data in a memory, such as but not limited to a flash memory array.

In accordance with some embodiments, a first hash value associated with a first set of data stored in a memory is compared to a second hash value associated with a second set of data pending storage to the memory. The second set of data is stored in the memory responsive to a mismatch between the first and second hash values.

These and other features and advantages which may characterize various embodiments can be understood in view of the following detailed discussion and the accompanying drawings.

### BRIEF DESCRIPTION OF THE DRAWINGS

FIG. 1 provides a functional block representation of an exemplary data storage device in accordance with some embodiments.

FIG. 2 illustrates an exemplary format for an erasure block from the memory of FIG. 1.

FIG. 3 is an arrangement of erasure blocks as formatted in FIG. 2.

FIG. 4 shows processing of a first set of write data presented for storage in the memory of FIG. 1 in accordance with some embodiments.

FIG. 5 illustrates processing of a second set of write data presented for storage in the memory of FIG. 1 in accordance with some embodiments.

FIG. 6 is an exemplary logic flow utilized by the comparison circuit of FIG. 5.

FIG. 7 is a flow chart for a FAST REJECT DATA WRITE routine generally illustrative of steps carried out in accordance with some embodiments.

### DETAILED DESCRIPTION

The present disclosure generally relates to the management of data in a memory, such as but not limited to data stored in a flash memory array.

In a writeback memory environment, host data are often provided to a storage device for writing to a memory of the storage device. The device acknowledges receipt of the data, and then schedules the subsequent writing of the data to the device during background processing operations. The use of writeback data processing can facilitate higher observed data transfer rates since the host is free to issue new access commands, and the storage device is free to service such commands, without the need to wait for the storage device to complete the physical writing of the data to the final memory destination.

Writeback data processing often involves the writing of the data to the final destination in a relatively short period of time. The data may be temporarily cached in a local memory pending transfer to the array, and so there may be an overall limit of how much writeback data can be accumulated pending transfer based on the capacity of the cache. If the cache is not power protected (e.g., a volatile memory), there may be some risk that the data may be lost due to a power interruption or other event that prevents the data from being stored in a final non-volatile location. The writing of data can also consume significant system resources, so that reducing the need to actually physically transfer writeback data to a memory can be valuable from a performance and wear standpoint.

Accordingly, various embodiments of the present disclosure provide an apparatus and method for managing data transfers in a data storage environment. As discussed below, in some embodiments a writeback system is configured to receive a set of write data for storage in a memory. The system writes the set of write data, and calculates one or more hash values which are also stored in memory.

Upon receipt of an updated version of the set of write data for storage in the memory, the system temporarily caches the new data and calculates new corresponding hash values. A sequence of comparisons are made between the respective hash values to quickly determine whether the updated version of the data is the same as, or is different from, the older version data set currently stored in the memory. If the data sets are found to be identical, further writeback processing is aborted, and the new set of data is not written. This can mitigate the unnecessary writing of data, freeing up resources for more productive uses and reducing memory wear and other effects.

A fast reject approach is used so that the comparisons are successively carried out with a view toward detecting differences between the respective data sets as quickly as possible. A hierarchical approach can be used with hash comparisons that promote successively increased levels of confidence. As soon as a particular comparison detects a difference between the data sets, further comparison processing ends and the new writeback data are scheduled for writing. Contrawise, if a particular comparison is indeterminate, the next level of comparison is performed. In this way, the comparisons continue until either a difference is detected, or until a sufficient level of confidence is obtained that the data sets are identical.

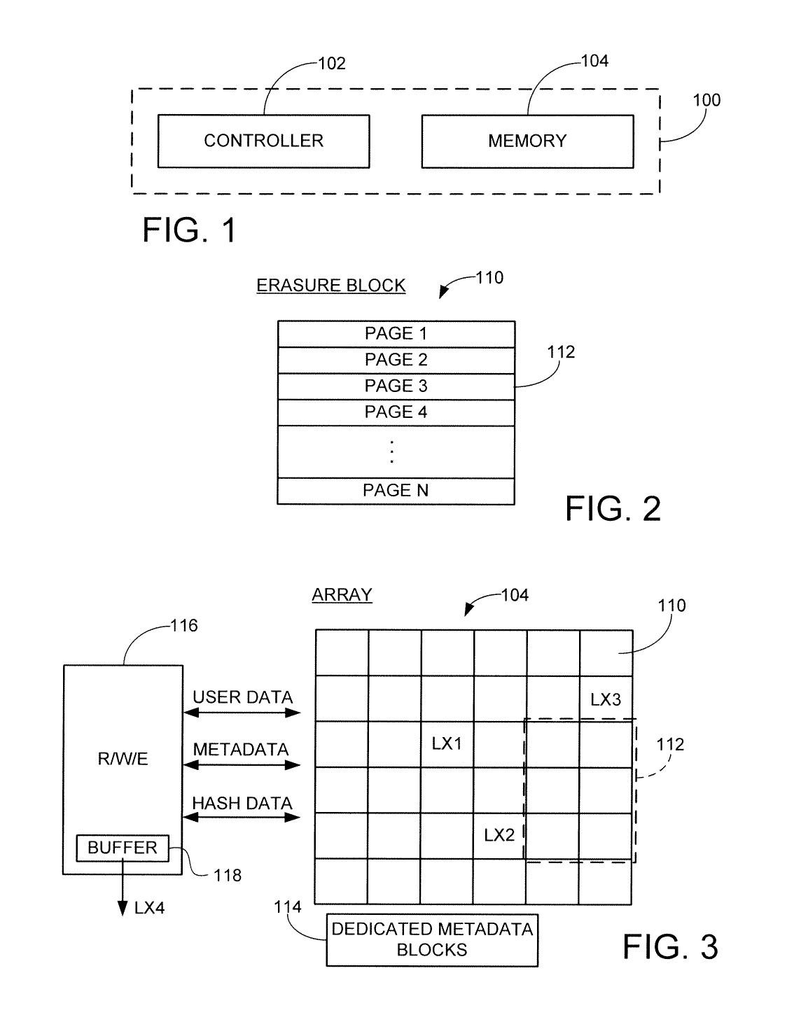

These and other features of the present disclosure can be understood beginning with FIG. 1 which shows illustrates an exemplary data storage device 100. The device 100 includes a controller 102 and a memory module 104. The controller 102 provides top level control for the device 100 and may be configured as a programmable processor with associated programming in local memory.

The memory module 104 can be arranged as one or more non-volatile memory elements such as rotatable recording discs or solid-state memory arrays. While a separate controller 102 is shown in FIG. 1, such is unnecessary as alternative embodiments may incorporate any requisite controller functions directly into the memory module. While not limiting, for purposes of the present discussion it will be contemplated that the data storage device 100 is a solid-state drive (SSD) that utilizes flash memory cells in the memory module 104 to provide a main data store for a host device (not shown).

The host device can be any device that communicates with the storage device 100. For example and not by way of limitation, the storage device may be physically incorporated into the host device, or the host device may communicate with the host device via a network using any suitable protocol.

The memory 104 may be arranged as individual flash memory cells arranged into rows and columns. The flash cells are configured such that the cells are placed into an initially erased state in which substantially no accumulated charge is present on a floating gate structure of the cell. Data are written by migrating selected amounts of charge to the floating gate. Once data are written to a cell, writing a new, different set of data often requires an erasure operation to remove the accumulated charge first before the new data may be written.

The physical migration of charge across the cell boundaries can result in physical wear. For this reason, flash memory cells are often rated to withstand only a limited number of write/erasure cycles (e.g., 10,000 cycles, etc.). Write mitigation as presented herein can thus extend the operational life of a flash memory array (as well as other types of memories), since unnecessary write/erase processing can be avoided.

The flash memory cells of the memory 104 can be arranged into erasure blocks 110, as generally depicted in FIG. 2. Each erasure block 110 is a separately addressable block of cells and represents the smallest unit of memory that can be concurrent erased at a time. Each row of cells may be referred to as a page 112, and each page is configured to store a selected amount of user data. In some cases, multiple pages of data may be stored to the same row through the use of multi-level cells (MLC). In some MLC conventions, two bits are stored in each cell, with the most significant bits (MSB) in the cells indicating the bit sequence of a first page of data, and the least significant bits (LSB) in the cells indicating the bit sequence of a second page of data.

Erasure blocks 110 may be grouped in the memory array 104 as as shown in FIG. 3. It is contemplated that the memory array 104 may include any number of such blocks, including blocks on different dies, strips, planes, chips, layers and arrays. Each of the erasure blocks 110 may be separately erasable, or groups of erasure blocks may be combined into larger, multi-block garbage collection units (GCUs) 114 which are allocated and erased as a unit.

The controller 102 may track control information for each erasure block/GCU in the form of metadata. The metadata can include information such as total number of erasures, date stamp information relating to when the various blocks/GCUs have been allocated, logical addressing (e.g., logical block addresses, LBAs) for the sets of data stored in the blocks 110, etc.

Block-level wear leveling may be employed by the controller 102 to track the erase and write status of the various blocks 110. New blocks can be allocated for use as required to accommodate newly received data. The metadata and other control information to track the data may be stored in each erasure block 110, or stored elsewhere such as in specific blocks 114 dedicated to this purpose.

FIG. 3 further shows a read/write/erase (R/W/E) circuit 116 which processes various transfers of data to and from the erasure blocks 110/114. The circuit 116 uses an associated buffer 118 to temporarily store data during such transfers. As explained below, the circuit 116 further generates and retrieves various types of hash values for use during writeback data operations.

Because flash memory cells usually cannot be overwritten with new data but instead require an erasure operation before new data can be written, the circuit 116 may write each new set of data received from the host to a different location within the array 104. FIG. 3 shows four different versions of a selected set of data which share a common LBA value (e.g., LBA 1001). These data sets are respectively denoted as LX1 through LX4. These represent an initial version of the data (LX1), a first updated version (LX2), a second updated version (LX3) and a third updated version (LX4). The versions were successively provided to the storage device by the host device over time. Each of these data sets may be the same size (e.g., 4 KB, etc.).

From FIG. 3 it can be seen that the R/W/E circuit 116 was able to determine that the first updated version (LX2) was different from the original version (LX1), since both were written to the array 104. That is, the set of bits in the LX2 version of LBA 1001 was found to be different, by at least one bit, from the set of bits in the LX1 version of LBA 1001. Responsive to this determination, the circuit 116 wrote the LX2 version to the next available location in the array. Similarly, upon the subsequent receipt of the LX3 version, the circuit was able to determine this version was different from the previous LX2 version, and the circuit scheduled the writing of the updated version LX3.

FIG. 3 further shows that the fourth LX4 version was determined by the circuit 116 to be bit-for-bit identical to the LX3 version, since the LX4 version was jettisoned from the buffer 118 instead of being written to the array 104. A subsequent host request for the LX4 version will result in the return of the most recent LX3 version.

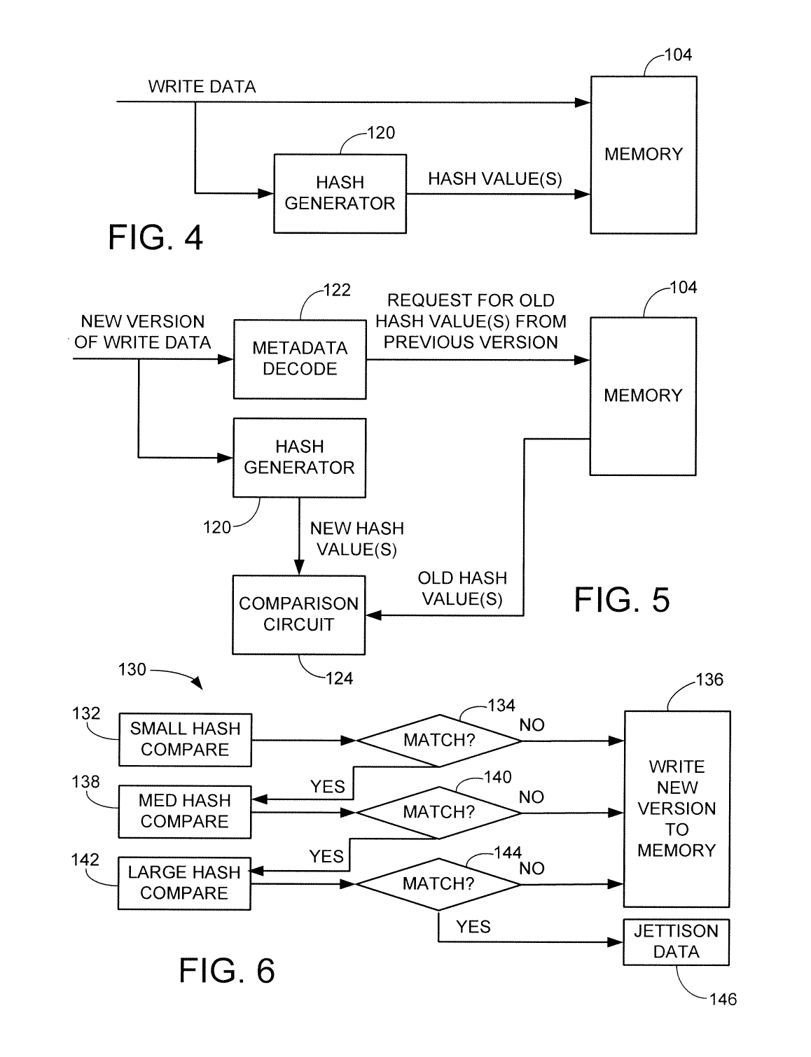

FIG. 4 shows a functional representation of selected operations by the circuit 116 during the writing of an initial version of a set of data, such as the LX1 data in FIG. 3. It is contemplated, albeit not required, that prior to the operation of FIG. 4 a determination will have been made that a previous version of the input data is not already stored in the array 104.

A hash generator block 120 operates to generate a set of hash values from the input write data. A hash function can be characterized as any number of different types of algorithms that map a first data set (a “key”) of selected length to a second data set (a “hash value”) of selected length. In many cases, the second data set will be shorter than the first set. The hash functions used by the hash generator block 120 should be transformative, referentially transparent, and collision resistant.

Transformation relates to the changing of the input value by the hash function in such a way that the contents of the input value (key) cannot be recovered through cursory examination of the output hash value. Referential transparency is a characteristic of the hash function such that the same output hash value will be generated each time the same input value is presented. Collision resistance is a characteristic indicative of the extent to which two inputs having different bit values do not map to the same output hash value. The hash functions can take any number of forms, including checksums, check digits, fingerprints, cryptographic functions, parity values, etc.

In some embodiments, one hash value can be a selected bit value in the input write data set, such as the least significant bit (LSB) or some other bit value at a selected location, such as the 13^{th} bit in the input value. Other hash values can involve multiple adjacent or non-adjacent bits, such as the as the 13^{th} and 14^{th} bits, the first ten odd bits (1^{st}, 3^{rd}, 5^{th}, . . . ), etc.

More complex hash functions can include a Sha 256 hash of the input data, as well as one or more selected bit values of the Sha 256 hash value (e.g., the LSB of the Sha hash value, etc.). Once generated, the hash values are stored in the memory 104 along with the input write data.

FIG. 5 depicts a subsequent receipt by the circuit 116 of a new version of the write data. This may correspond, for example, to the LX2 version of data discussed above in FIG. 3. The presence of the previous LX1 version of the data in the array 104 can be determined through a metadata decode block 122. The decode block 122 accesses the metadata stored in the system to determine if the previous version exists, and if so, to return the associated hash values that were previously stored in FIG. 4.

The hash generator 120 from FIG. 4 operates in FIG. 5 to a second, new set of hash values from the input LX2 write data. The same types and kinds of hash values are generated as were generated for the previous LX1 data. An entire set of hash values can be generated for the new data, or the hash values can be generated on-the-fly as needed to save unnecessary computations.

A comparison circuit 124 successively compares the hash values for the previous set of data to the hash values to the new set of data. At any time, should a mismatch occur further comparisons are halted and the circuit 116 schedules the writing of the new version of data at the next appropriate time during background processing. Matches between hashes result in the selection of the next hash pair and the process continues.

FIG. 6 is a logic flow representation 130 of steps carried out by the comparison circuit 124 in FIG. 5 in accordance with some embodiments. In FIG. 6, a total of three (3) hash value pairs are used, so-called “small,” “medium” and “large” hash values. Other numbers of hash value pairs can readily be used depending on the requirements of a given application. More hash pairs may operate to provide higher levels of confidence at the expense of further computation processing resources.

For purposes of the present example, it will be contemplated that the small hash compare is a single bit in the respective input data sets, such as the last bit (LSB). This comparison takes place at block 132 using any suitable mechanism such as, but not limited to, an exclusive or (XOR) comparison of the two values. A determination is made at decision step 134 whether the two bits match.

It will be recognized that, in a base-2 system, each bit can have one of two possible values, either a 0 or a 1. Assuming normal bit distributions, there is about a 50% probability that these two individual bits in the respective data sets will match, and about a 50% probability that the two bits will not match. However, it can be seen that if the two bits do not match, the probability that the two sets are different (by at least one bit) becomes 100%. Accordingly, the flow continues to step 136 where the new version of data is immediately scheduled for writing to the memory, and further comparisons are omitted.

At the same time, if the LSB of both data sets are the same value (e.g., both are a logical 1), this reveals substantially nothing regarding whether the overall data sets are identical or not. A small hash compare match thus provides an indeterminate state and so further comparisons are made. In this way, the system provides a fast reject process in that the system attempts to obtain a hash mismatch, if one can be had, as quickly as possible.

The flow of FIG. 6 thus passes to step 138 where the medium hash values are next compared. In some embodiments, the medium hash value is a selected bit value of a Sha 256 hash function, such as the LSB of the resulting hash value. It follows that in this example, the processing of the hash generator in FIGS. 4 and 5 generated a Sha 256 hash value for each set of data, and further identified the LSB of each of these resulting hash values as the respective medium hash values.

It can be seen that the LSB of a Sha 256 hash value (or some other transformative hash value) in a base-2 system can still only be either a 0 or 1. However, because of the referential transparency and collision resistance characteristics of a Sha hash function, the matching or non-matching of the LSB of resulting Sha hash values may be more statistically significant than for the LSBs of the input data sets. Clearly, the probability that the data sets are different if the LSBs do not match is once again substantially 100%. The probability that the data sets are the same if the LSBs match, however, may tend to be higher than if just the LSBs of the raw input data match.

Accordingly, as before the comparison circuit 124 provides fast reject processing; if the LSBs of the respective Sha hash values do not match, the flow passes from step 140 to step 136 and the input data is scheduled for writing to the array 104. If the LSBs of the respective Sha hash values match, the flow passes to step 142 for the large hash comparison.

In the current example, the large hash values constitute the full Sha hash values. It will be appreciated that other hash values can be used. Because of the high collision resistance and high referential transparency of the Sha hash function, a match provides a high level of confidence that the two input data sets are the same, and a mismatch provides a correspondingly high level of confidence that the two input data sets are different.

Accordingly, decision step 144 determines whether the respective Sha hash values match; if not, the input data are scheduled for writing. If so, no further action is taken and the input data set is jettisoned, as indicated by block 146. In each case, if a decision is made to proceed with the writing of the data set to the memory, the corresponding hash values are stored as well.

While the foregoing embodiments have stored the hash values in the memory array, in other embodiments the hash values can be stored elsewhere in the system, including being loaded into fast local memory during system initialization.

Depending on the system, it is contemplated that the first hash value comparison step may result in the identification of a fast reject about 1½ⁿ of the time, which will tend to approach 50% assuming random data distributions. As noted above, if the first hash values match, it is indeterminate whether the new data is merely a copy of the old data, or is different. Thus, the system proceeds to calculate and compare successive pairs of hashes of successively larger sizes until it is concluded, with sufficient confidence, that the new data is truly different or merely a copy.

In some embodiments, the foregoing processing is applied to all write data sets provided for writing to the memory. Alternatively, the fast reject processing is only applied to certain types of data, such as hot data (e.g., data that have been written and read at a relatively high frequency over an associated period of time).

Some benefits of this approach may include the ability to avoid the unnecessary writing of data to memory, as well as avoiding the need to perform a full comparison of the two full sets of data in order to determine whether the data sets are the same or different. For example, if the hash values are precalculated there is no particular need to read out the previously stored version of the data from the memory at all. In some embodiments, however, such retrieval and on-the-fly hash value calculations can be performed.

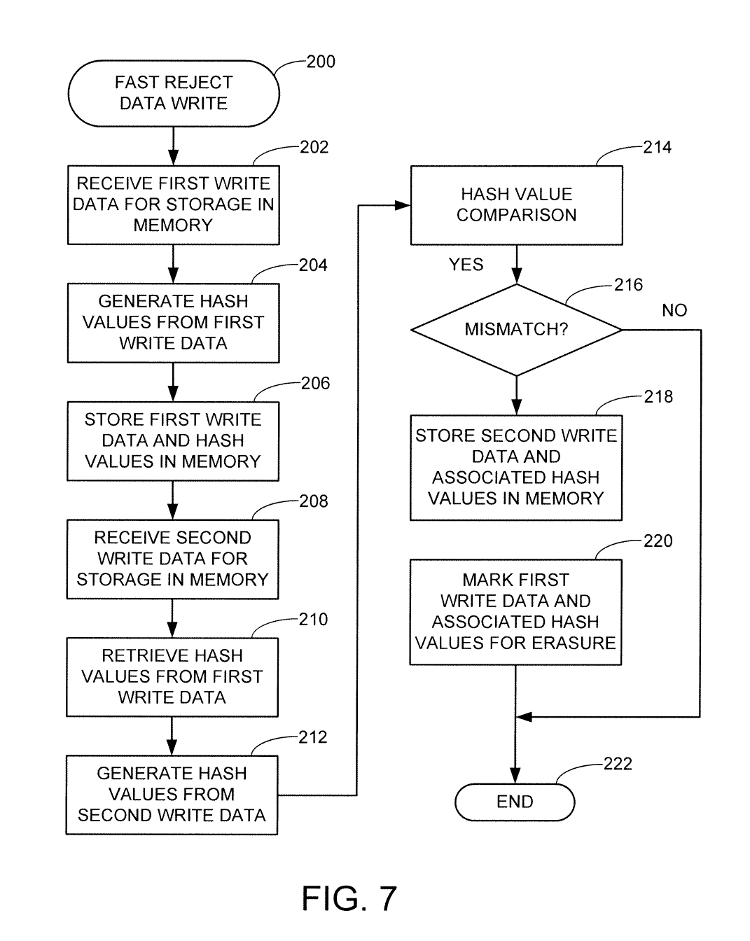

FIG. 7 provides a flow chart for a FAST REJECT DATA WRITE routine 200, which generally summarizes steps that may be carried out in accordance with some embodiments. The device 100 will be used as an example to explain the routine, although the routine can be utilized with other types of data storage devices and other operational environments.

A first set of write data is received for storage into a memory at step 202. A set of hash values is generated from the first write data at step 204, and both the input write data and the hash values are stored in suitable memory locations at step 206. These steps correspond to FIG. 4.

A second set of write data is subsequently received at step 208 for storage to memory. In order to determine whether this new data is different from, or merely a copy of previously stored data in the memory, the hash values associated with the first write data are retrieved from memory, step 210, and a second set of hash values for the new data is generated, step 212. These steps generally correspond to FIG. 5.

A hash value comparison operation next takes place at step 214. This can include the various comparisons and decision points set forth in FIG. 6. It will be appreciated that a fast reject process is used so that the types of hash values and comparisons made therebetween are weighted to urge as quick detection of differences between the respective data sets.

Ultimately, a decision is made either way, as shown by decision step 216. If a mismatch is found, the process continues to step 218 where the second write data and the associated hash values are stored in memory. As desired, the first write data and associated hash values can be marked for erasure as being stale (out of revision) data, step 220, after which the process ends at step 222. If the data sets are found to match through comparisons of the respective hash values, the flow passes immediately from step 216 to step 222.

While various embodiments have been directed to a flash memory environment, such is not necessarily limiting. Comparison of respective hash values, as used herein, will specifically exclude the wholesale comparison of all the bits of a first data set to all of the bits of a second data set since such operation is specifically rendered unnecessary in order to determine whether the second set is a copy of the first set.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising comparing a first hash value associated with a first set of data stored in a memory to a second hash value associated with a second set of data pending transfer to the memory, and storing the second set of data in the memory responsive to a mismatch between the first and second hash values.

2. The method of claim 1, further comprising comparing a third hash value associated with the first set of data to a fourth hash value associated with the second set of data responsive to the first hash value matching the second hash value.

3. The method of claim 1, in which the first and second sets of data share a common logical address, and the mismatch between the first and second hash values indicates the second set of data is an updated, different version of the first set of data.

4. The method of claim 1, in which the first hash value is characterized as a logical value of a selected bit location of the first set of data and the second hash value is characterized as a logical value of the same bit location of the second set of data.

5. The method of claim 1, in which the first hash value is determined responsive to application of a Sha hash function to the first set of data, and the second hash value is determined responsive to application of the Sha hash function to the second set of data.

6. The method of claim 5, in which the first hash value is less than all of the bits of a resulting hash value obtained by application of the Sha hash function to the first set of data, and the second hash value is less than all of the bits of a resulting hash value obtained by application of the Sha hash function to the second set of data.

7. The method of claim 1, in which the memory is characterized as a flash memory array and the first and second sets of data are stored in different erasure blocks of the array.

8. An apparatus comprising a memory and a control circuit adapted to store a first set of writeback data and an associated first set of hash values in the memory, the control circuit further adapted to, responsive to a subsequent receipt of a second set of writeback data, generate a second set of hash values, compare the second set of hash values to the first set of hash values, and store the second set of data in the memory responsive to a mismatch between the first and second sets of hash values.

9. The apparatus of claim 8, in which the first set of writeback data is stored in a first location in the memory, and the second set of writeback data is stored in a different, second location in the memory.

10. The apparatus of claim 8, in which each of the first and second sets of hash values comprises a small hash value, a medium hash value and a large hash value, the comparison of the respective sets of hash values comprises a successive comparison of the respective small hash values, followed by a comparison of the respective medium hash values, followed by a comparison of the respective large hash values.

11. The apparatus of claim 8, in which the first and second sets of writeback data share a common logical address, and the mismatch between the first and second sets of hash values indicates the second set of writeback data is an updated, different version of the first set of writeback data.

12. The apparatus of claim 8, in which the second set of writeback data is temporarily stored in a buffer pending transfer to the memory, and the control circuit is further adapted to jettison the second set of data from the buffer so that the second set of writeback data is not transferred to the memory responsive to the first set of hash values matching the second set of hash values.

13. The apparatus of claim 8, in which the memory is characterized as a flash memory array and the respective first and second sets of writeback data are stored in different locations within the flash memory array.

14. A method comprising:
generating a first set of hash values responsive to receipt of first writeback data;
storing the first writeback data and the first set of hash values in a memory;
generating a second set of hash values responsive to receipt of second writeback data; and
storing the second set of writeback data in the memory responsive to a mismatch between the first and second sets of hash values indicative of a difference between the first and second writeback data, else jettisoning the second writeback data without storage thereof in the memory responsive to a match between the first and second sets of hash values indicative that the second writeback data is an identical copy of the first writeback data.

15. The method of claim 14, in which the first set of hash values comprises a multi-bit hash value generated responsive to application of a selected hash function to the first writeback data, and the second set of hash values comprises a multi-bit hash value generated responsive to application of the selected hash function to the second writeback data.

16. The method of claim 15, in which the selected hash function is a Sha hash function.

17. The method of claim 15, in which a selected one of the hash values in each of the first and second sets of hash values is a selected bit location in the respective multi-bit hash values.

18. The method of claim 15, in which the first and second sets of hash values each further comprise a selected bit location of the respective first and second writeback data.

19. The method of claim 14, further comprising successively comparing respective pairs of the first and second sets of hash values in turn prior to the storing step.

20. The method of claim 14, in which the first and second writeback data share a common logical block address (LBA).
